(19) United States
(12) Patent Application Publication
(10) Pub. No.: US 2007/0197383 A1
(43) Pub. Date: Aug. 23, 2007

(54) Method for Detecting Damage

(75) Inventors: Bryan E. Koene, Blacksburg, VA (US); Martin E. Rogers, Blacksburg, VA (US)

Correspondence Address: JOY L BRYANT, P.C., P O BOX 620, LIGHTFOOT, VA, 23090-0620, US

(73) Assignee: Luna Innovations Incorporated, Blacksburg, VA (US)

(21) Appl. No.: 11/278,045

(22) Filed: Mar. 30, 2006

Related U.S. Application Data
(60) Provisional application No. 60/667,141, filed on Mar. 31, 2005.

(51) Int. Cl. B41M 5/20

(52) U.S. Cl. 503/201

(57) ABSTRACT

A method for detecting damage to an article caused by exposure to pressure is provided. The article is covered by a pressure sensitive material comprising at least one dye and at least one activator. As the article is exposed to pressure, the pressure sensitive material undergoes a color change in response to exposure to a pressure wherein the article is damaged.

### CROSS-REFERENCE TO RELATED APPLICATIONS

This application claims the benefit of U.S. Provisional Patent Application Ser. No.60/667,141, entitled, “Method for Detecting Damage,” filed Mar. 31, 2005, which is hereby incorporated by reference in its entirety.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Contract No. FA8650-04-M-5010 awarded by the United States Air Force.

### FIELD OF THE INVENTION

The present invention relates to a method of detecting damage. In particular, it relates to a method that employs a pressure sensitive material containing a dye and an activator that, upon exposure to various pressures, causes a color change in the pressure sensitive material at the point of exposure.

### BACKGROUND OF THE INVENTION

When a structural component is suspected of having undergone some type of damage, it is necessary to evaluate the component to determine where the damage has occurred and whether or not it remains fit for use. Typically, non-destructive evaluation techniques such as x-ray microscopy, scanning acoustic microscopy (SAM), Environmental Scanning Electron Microscopy (E-SEM), Energy Dispersive Spectrometry (EDS), infrared imaging, fiber optics, and other spectroscopic techniques are used to evaluate the extent of damage (if any) done to a structural component or material. The problem with these techniques is that they require complete removal or detachment of the component from the structure in order to be evaluated. In addition, it is difficult to determine specific points of damage in a short amount of time because large areas of the structure need to be scanned. Therefore, it is desirable to have a technique where either upon visual inspection or through the employment of a hand-held device, such as an ultraviolet light, damage can be easily detected.

An object of the present invention is to provide a method for detecting damage by employing a material that manifests a color change when an article has been damaged or subjected to tampering.

Another object of the present invention is to provide a method of determining damage either visually or through the use of an ultraviolet light.

### SUMMARY OF THE INVENTION

By the present invention, a method is provided for determining when an article has been damaged or tampered with by using a pressure sensitive material. By damage, it is meant that the article on which the pressure sensitive material is placed loses one or more of its inherent physical properties due to exposure to a mechanical, thermal, radiation, or other incident. Examples of the inherent physical properties of the article include but are not limited to structural mechanical properties (e.g. composite structure) or barrier properties (e.g. polymer protective film or coating) of the article. By pressure sensitive, it is meant that when the material is subject to certain impact energy or torque, the material undergoes a color change indicative of the damage realized. The pressure sensitive material includes but is not limited to pressure sensitive coatings, adhesives, and films. In practicing the method of the present invention, an article is provided. A pressure sensitive material is also provided. The pressure sensitive material comprises at least one type of dye and at least one type of activator. The pressure sensitive material is applied to the article. The article is exposed to pressure (e.g., impact energy or torque) wherein the pressure sensitive material changes color in response to exposure to a pressure wherein the article is damaged.

The method of the present invention is employed where it is desirable to check impact damage of structural components. The method is also suitable for use where evidence of tampering is desired, such as tampering with food and drink packaging materials, packaging materials in general, or medicinal packages.

Additional objects and advantages of the invention will be set forth in part in the description which follows, and in part, will be obvious from the description, or may be learned by practice of the invention. The objects and advantages of the invention will be obtained by means of instrumentalities in combinations particularly pointed out in the appended claims.

### BRIEF DESCRIPTION OF THE DRAWINGS

The accompanying drawings illustrate a complete embodiment of the invention according to the best modes so far devised for the practical application of the principles thereof, and in which:

FIG. 1 is a schematic depiction of the method of the present invention.

FIG. 2 is a schematic depiction of the co-encapsulation of a dye and an activator.

### DETAILED DESCRIPTION OF THE PREFERRED EMBODIMENTS

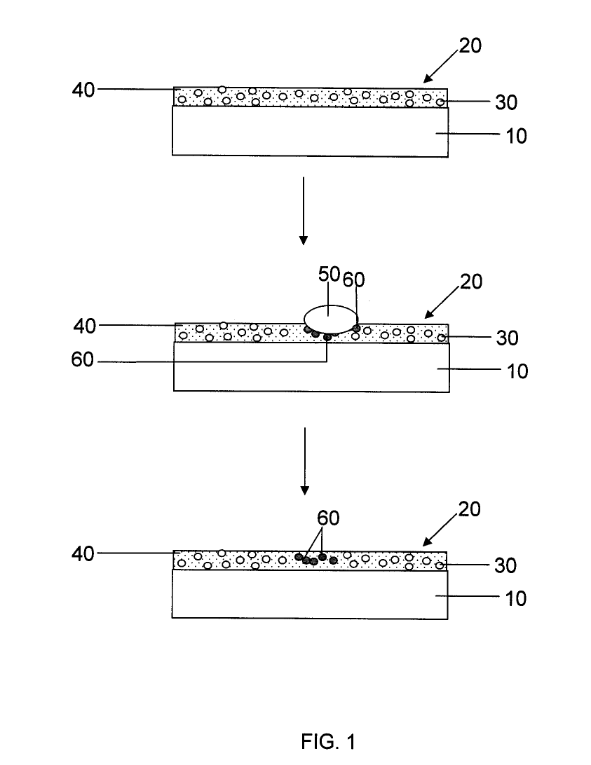

By the present invention, a method for determining damage or tampering of an article is provided. In practicing the method of the present invention, as depicted in FIG. 1, an article 10 is provided. Any article that may be subjected to coating or covering by a material is suitable for the method of the present invention. In particular, structural composites such as aircraft, boats, automobiles, and helmets are suitable articles. Alternatively, the method may be used for food and drink packaging, medicinal packaging materials, envelopes and boxes. A pressure sensitive material 20 is also provided. In general, the pressure sensitive material 20 comprises at least one type of dye 30 and at least one type of activator 40. The activator 40 or color developer is used in combination with the dye 30 such that when the dye 30 comes into contact with the activator 40, the dye undergoes a color change. Typically, the dye 30 and the activator 40 are incorporated with a polymer to form the pressure sensitive material 20. The pressure sensitive material 20 is applied to the article 10 so as to cover a portion of the article or, alternatively, the entire article. As the article 10 is exposed to pressure 50 (such as impact energy or torque) which causes damage to the article, the pressure sensitive material 20 undergoes a color change at the point of exposure resulting from the dye 30 coming into contact with the activator 40. Therefore, localized damage to an article can easily be detected by the manifestation of a localized color change 60 in the pressure sensitive material 20. In the event the pressure does not cause damage to the article, no color change occurs.

The polymer used for the pressure sensitive material may be any polymer known to one of ordinary skill in the art, and the choice of the polymer is specific for the application. For example, should the method be applicable to detection of impact with respect to aircraft, the pressure sensitive material is a polymeric coating prepared from a solvent based polymeric resin system such as polyurethane or epoxy. Alternatively, should the method be applied to the detection of tampering in food and drink packaging, the pressure sensitive material is a polymeric film prepared from polyethylene. Examples of other polymeric systems include but are not limited to thermoplastic films prepared from vinyl-acetate, polyvinyl chloride, acrylic-containing polymers, polyamides, polyoelfins, styrene polymers, and polyesters. Alternatively, thermosetting resins used in coatings, adhesives and composites are also useful for preparing the pressure sensitive material. Some specific polymeric systems include but are not limited to waterborne polyurethane, waterborne epoxy, waterborne acrylic, waterborne rubber, solvent based epoxy resin systems, solvent based polyurethane systems (one-part and two-part systems), polystyrene foams, polyethylene terephthalate, and oriented films.

Regardless of the polymeric system employed, all of the systems are made pressure sensitive through the incorporation of at least one type of dye and at least one type of activator. Preferably, the dye is a microencapsulated dye. Any microencapsulated dye known to those of ordinary skill in the art may be employed. Various dyes are selected based on the final application. For example, in detection of damage to an aircraft, microcapsules containing a fluorescent dye are incorporated into a polymeric coating. When the coating is subject to certain impact strength that causes damage to the article, the microcapsules break exposing the dye to the activator, causing a visible color change at the point of impact. In some instances, the article is exposed to an ultraviolet light after it has been subject to impact and the color change is observed under ultraviolet light. Depending on the dye employed, the coating will either undergo a visual color change or a color change that is evidenced when the article is exposed to an ultraviolet or black light. Examples of these fluorescent dyes include but are not limited to: fluorescein and calcein dyes. Other types of dyes are compounds selected from the classes known generically in the art as phthalides, phonthiazines, fluorans, arylsulfonylmethanes, furopyridinones and furopyrazinoes. More specific examples of these dyes are founding U.S. Pat. No. 4,363,664 to Delaney which is hereby incorporated by reference in its entirety. Chromogenic compounds may also be employed as dyes. Such chromogens include crystal violet lactone, benzoyl leuco methylene blue, fluorans, phthalides, rhodamine lactams such as those described in U.S. Pat No. 4,425,386 to Chang and U.S. Pat. Nos. 3,954,803 and 4,012,419 to Vincent and Chang which are hereby incorporated by reference in their entirety. Other types of dyes include diarylmethanes, triaylmethanes, indolylphthalides, azaphthalides, fluorans, and spiropyrans such as those listed in U.S. Patent Number 5,605,873 to Chang and is hereby incorporated by reference in its entirety. Preferably, the dyes are visible dyes of the type known as Leuco dyes, which undergo color change with a change in the pH. These dyes are commercially available from Ciba under the trademark known as PERGASCRIPT:
Ciba® PERGASCRIPT® BLACK I-2R
Ciba® PERGASCRIPT® BLACK I-R
Ciba® PERGASCRIPT® BLACK T-2R SM
Ciba® PERGASCRIPT® BLACK T-R
Ciba® PERGASCRIPT® BLUE I-2RN
Ciba® PERGASCRIPT® BLUE S-RB
Ciba® PERGASCRIPT® BLUE S-RB P
Ciba® PERGASCRIPT® GREEN I-2GN
Ciba® PERGASCRIPT® ORANGE I-G
Ciba® PERGASCRIPT® RED I-6B

Alternatively, in a food or drink packaging application, the microencapsulated dye is one that undergoes a visual change when pressure (or torque) is applied that may damage the article or show signs of tampering. For example, the microencapsulated dye is incorporated into a heat shrink film that is wrapped around a bottle cap. If the bottle cap is tampered with, the film will form a noticeable color change at the place of tampering.

The pressure sensitive material is applied to the article using application methods suitable to the industry needs. For example, when the pressure sensitive material is a polymeric coating, the coating is applied to the article by application techniques such as spraying, spin-coating, rolling, or dipping. Alternatively, when the pressure sensitive material is a polymeric film, the polymeric film is wrapped around the article and heat-shrunk into place. Similarly, the pressure sensitive material is an adhesive that is applied to a package such as a box or an envelope.

The pressure sensitive material is capable of undergoing a color change upon exposure to pressure that is capable of causing damage to an article. The amount of pressure required to cause the pressure sensitive material to change color is tailored specific to the application. Therefore, the sensitivity of the pressure sensitive material will range from extremely sensitive, where the slightest exposure to pressure will trigger a color change to relatively insensitive where high impact pressure or changes in torque are needed to trigger a color change. The sensitivity is determined by the characteristics of the microencapsulates employed in the application. Without being bound to theory, small microencapsulates are less sensitive to breaking under pressure. Likewise, microencapsulates having thicker walls/shells are less sensitive to pressure than microencapsulates having thinner walls/shells. Shell composition affects the resulting product and can be varied as desired to obtain the pressure sensitivity and compatibility with the host resin. Examples of the composition of the shell of the microcapsule include but are not limited to: gelatin, starch, formaldehyde polymers, epoxies, urethanes, polyamides, and polyesters.

In some cases, it is desirable to determine whether or not an article has been exposed to a range of pressure changes. When that is the case, combinations of microencapsulates having varied wall/shell thicknesses and different dye colors are employed. Hence, a spectrum of pressure or torque intensities is established. When combinations of different dye types are employed, it is necessary to use more than one type of activator to develop the different dyes. Alternatively, it was found that color intensity increases with an increase in impact energy, so the higher the impact strength, the stronger the color intensity of the dye.

The activator serves as a color developer and is incorporated into the pressure sensitive material either as is, through encapsulation, or co-encapsulation with the dye. The activator enables the dye to manifest itself when the dye comes into contact with the activator. One such activator is a proton donating material such as a Bronsted acid. Such acids include but are not limited to alkylphenol-formaldehyde novalac resins, zinc salts of alkylsalicyclic acids, and acid activated clays. Alternatively, the activator may be basic in nature. Various dye and color developer systems are developed based on the desired application.

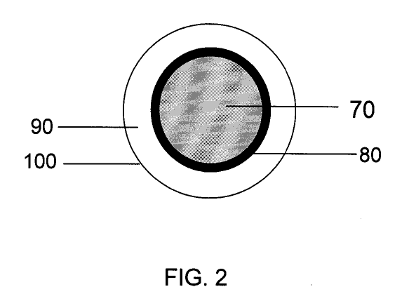

FIG. 2 depicts one embodiment of the invention wherein the dye is co-encapsulated with the activator. As shown, the dye 70 forms a core within the encapsulate. There is a barrier layer 80 which surrounds the dye and isolates it from the activator 90 which surrounds the barrier layer. An outer shell layer 100 surrounds the activator. Alternatively, the activator may be located in the core of the co-encapsulate and the dye surround the activator. The sensitivity of the co-encapsulate to various impact or torque energies is controlled by the material used to form the outer shell of the co-encapsulant.

In a most preferred embodiment of the invention, the dye is a leuco dye. A leuco dye is a dye whose molecules can acquire two forms, one of which is colorless. These types of dyes change their absorbance or emission wavelengths through various activation mechanisms which include but are not limited to, acid-base reactions, metal chelation, exposure to radiation (such as UV radiation), exposure to heat, and other types of exposures. Preferably, the activation mechanism is an acid-base reaction in which an activator having a pKa less than that of the dye is used. Such activators include but are not limited to: phenol or substituted phenols (salicyclic acid, benzoic acid, hydroxyl benzoic acid, zinc salicylate), solid acids (boric acid), polymeric acids (polystyrene sufonic acid, polyacrylic acid). When the leuco dye is exposed to the activator, color shifts in the wavelength of color absorption is observed. Depending on the type of dye, the color shift may occur on exposure to either an acid or under alkaline conditions. Alternatively, some dyes change their emission spectra with changes in the pH. Examples of these types of dyes include but are not limited to: quinine, fluorescein, and calcein.

### EXAMPLE 1

Dye filled microcapsules, known as HRJ 13944, HRJ 14893, and HRJ 14894, commercially available from Schenectady International, Incorporated, were blended with color developers (or activators), known as HRJ 4023 and HRJ 14508 also commercially available from Schenectady International, Incorporated, and mixed with a paint known as Solucote 1073 commercially available from Soluol, Inc., according to the amounts shown in Table 1. The impact indicator paints were cast at 1-3 mils (0.001-0.003″) onto a coated panel, using a drawdown blade. A Universal Impact Tester (Gardco Model 173) was used to evaluate the impact indicator paint. A 2 lb standard weight was dropped from a measured distance through a tube to impact the coated panel. A ¼″ diameter ball point was used at the end of the 2 lb weight to focus the energy on the coated panel (used for evaluating flexibility and impact properties of coatings). The change in intensity of coloration was observable by eye. The intensity of coloration changed with impact energy (measured by the weight of the impactor multiplied by the height from which the ball was dropped). Table 1 provides the details and results of the experiments. The impact color change is designated on a scale from 0-5 (0—no change; 5—high change of color at any impact level).

TABLE 1

| | | | | | | | Color |
|---|---|---|---|---|---|---|---|
| | Dye Microcapsules | | | Activator | | Paint | Change |
| Sam- | HRJ | HRJ | HRJ | HRJ | HRJ | Solucote | with |
| ple | 13944 | 14893 | 14894 | 4023 | 14508 | 1073 | Impact |
| 164A | 0.5 g | | | | 1 g | 8 g | 0 |
| 164B | 1 g | | | | 1 g | 8 g | 0.5 |
| 164C | 1 g | | | | 2 g | 8 g | 1 |
| 164D | 2 g | | | | 2 g | 8 g | 2 |
| 164E | 1 g | | | 2 g | | 8 g | 5 |
| 164F | | 1 g | | | 1 g | 8 g | 0 |
| 164G | | 1 g | | | 2 g | 8 g | 1 |
| 164H | | 1 g | | 2 g | | 8 g | 5 |
| 164I | | | 1 g | | 1 g | 8 g | 1 |
| 164J | | | 1 g | | 2 g | 8 g | 2 |
| 164K | | | 1 g | 2 g | | 8 g | 5 |

### EXAMPLE 2

Dye microcapsules and activators were incorporated into a waterborne latex paint with the amounts described in Table 2. Substrates were coated and tested as described in Example 1. The impact color change was designated on a scale from 0-5 (0—no change; 5—high change of color at any impact level). The change in intensity of coloration was readily observable by the eye.

TABLE 2
Details of Microcapsule/Latex Formulations

| | | | | | | | | Color |
|---|---|---|---|---|---|---|---|---|
| | Dye Microcapsules | | | | Activator | | | Change |
| Sam- | HRJ | HRJ | HRJ | | HRJ | HRJ | Paint | with |
| ple | 13944 | 14893 | 14894 | | 4023 | 14508 | Latex | Impact |
| 152A | | | 0.25 | g | | 0.5 g | 9.25 g | 1 |
| 152B | | | 0.5 | g | | 0.5 g | 9 g | 2 |
| 152C | | | 0.75 | g | | 0.5 g | 8.75 g | 2 |
| 152D | | | 1 | g | | 0.5 g | 8.5 g | 3 |
| 152E | | | 1.25 | | | 0.5 g | 8.25 g | 3 |
| 152F | | | 1.5 | | | 0.5 g | 8 g | 4 |
| 152G | | | 1 | g | | 0.25 g | 8.75 g | 2 |
| 152H | | | 1 | g | | 0.5 g | 8.5 g | 3 |
| 152I | | | 1 | g | | 0.75 g | 8.25 g | 3 |
| 152J | | | 1 | g | | 1 g | 8 g | 4 |
| 152K | 1 g | | | | 0.5 g | | 8.5 g | 1 |
| 152L | 1 g | | | | | 0.5 g | 8.5 g | 2 |
| 152M | | 1 g | | | 0.5 g | | 8.5 g | 1 |
| 152N | | 1 g | | | | 0.5 g | 8.5 g | 1 |
| 152O | | | 1 | g | 0.5 g | | 8.5 g | 3 |
| 152P | | | 1 | g | | 0.5 g | 8.5 g | 3 |

### EXAMPLE 3

Microspheres and activators were incorporated into an anionic waterborne polyurethane dispersion. Table 3 provides examples of these formulations and impact results. Substrates were coated and tested as described in Example 1. The impact color change was designated on a scale from 0-5 (0 —no change; 5—high change of color at any impact level).

TABLE 3
Details of Microcapsule/Polyurethane Formulations

| | Dye | | | | |
|---|---|---|---|---|---|
| | Microcapsules | Activator | | Paint | |
| | HRJ | HRJ | | Anionic | Color Change with |
| Sample | 14894 | 4023 | Phenol | PUD | Impact |
| 157A | 0.5 g | 0.5 g | | 9 g | 1 |
| 157B | 1 g | 1 g | | 8 g | 3 |
| 157C | 0.5 g | | 0.5 g | 9 g | 1 |
| 157D | 1 g | | 1 g | 8 g | 4 |

### EXAMPLE 4

Initial experiments with the Desothane resulted in coatings that did not exhibit a color change upon impact. The use of a phenol added to the formulation resulted in the desired color change when added in the amounts listed in Table 4.

TABLE 4
Details of Microcapsule/Desothane Formulation

| | | | | | | Color |
|---|---|---|---|---|---|---|
| | Dye | | | | | Change |
| | Microcapsules | Activator | | | Paint | with |
| Sample | HRJ 14894 | HRJ 14508 | HRJ 4023 | Phenol | Desothane HS | Impact |
| 170-1 | 0.5 g | 1 | | | 6 g + 2 g Part A/ | 0 |
| | | | | | Part B | |
| 170-2 | 0.5 g | | 1 | | 6 g + 2 g Part A/ | 0 |
| | | | | | Part B | |
| 170A | 0.5 g | 1 g | | 0.5 g | 6 g + 2 g Part A/ | 2 |
| | | | | | Part B | |
| 170B | 0.5 g | | 1 g | 0.5 g | 6 g + 2 g Part A/ | 4 |
| | | | | | Part B | |

### EXAMPLE 5

Microcapsules were added to a solvent-borne epoxy (Desoprime-PPG Aerospace) in the amounts listed in the formulation (Table 5). Substrates were coated and tested as described in Example 1. The impact color change was designated on a scale from 0-5 (0 —no change; 5—high change of color at any impact level). Similar to the two part polyurethane, no color change was observed without the addition of phenol.

TABLE 5
Details of Microcapsule/Desothane Formulation

| | | | | | Color |
|---|---|---|---|---|---|
| | Dye | | | | Change |
| | Microcapsules | Activator | | Paint | with |
| Sample | HRJ 14894 | HRJ 4023 | Phenol | Desoprime | Impact |
| 179-1 | 1 g | 1 g | | 5 g + 5 g Part | 0 |
| | | | | A/Part B | |
| 179A | 1 g | 1 g | 0.5 g | 5 g + 5 g Part | 2 |
| | | | | A/Part B | |

### EXAMPLE 6

Microcapsules were added to a water-borne epoxy (Ancarez-Air Products) in the amounts listed in the formulation (Table 6). Substrates were coated and tested as described in Example 1. The impact color change is designated on a scale from 0-5 (0—no change; 5—high change of color) for varying impact level (Table 7). A 2 lb conical weight is dropped from selected distances as listed in the table. Samples with dye microcapsules and activator show a consistently increasing intensity of coloration with increasing impact energy. Samples with dye microcapsules, but no activator show no coloration at any impact level, thus indicating that the presence of an activator is essential to the method.

TABLE 6
Details of Microcapsule/Ancarez Epoxy Formulation

| | | | | Epoxy Part |
|---|---|---|---|---|
| | Dye Microcapsules | Activator | Epoxy Part A | B |
| Sample | HRJ 14894 | HRJ 4023 | Ancarez | Anquamine |
| 184C | 1 g | 1 g | 5.5 g | 1.0 g |
| 184D | 1 g | 0 g | 5.5 g | 1.0 g |

TABLE 7
Coloration for varying impact level for impact indicating paints
designated in Table 6 (coloration on scale of 0-5, zero no change
in color, 5 very high color change)

| | Coloration Level | |
|---|---|---|
| Height | 184C | 184D |
| (inches) | (with activator) | (no activator) |
| 0 | 0 | 0 |
| 1 | 0 | 0 |
| 2 | 0 | 0 |
| 3 | 1 | 0 |
| 4 | 1 | 0 |
| 5 | 2 | 0 |
| 6 | 2 | 0 |
| 7 | 3 | 0 |
| 8 | 4 | 0 |
| 9 | 5 | 0 |
| 10 | 5 | 0 |

The above description and drawings are only illustrative of preferred embodiments which achieve the objects, features and advantages of the present invention, and it is not intended that the present invention be limited thereto. Any modification of the present invention which comes within the spirit and scope of the following claims is considered part of the present invention.

What is claimed is:

1. A method for detecting damage, the method comprising the steps of:
a) providing an article;
b) providing a pressure sensitive material comprising at least one dye and at least one activator;
c) applying the pressure sensitive material to the article; and
d) exposing the article to pressure wherein the pressure sensitive material undergoes a color change in response to exposure to a pressure wherein the article is damaged.

2. A method according to claim 1, wherein the article is selected from the group consisting of: an aircraft structure; a boat; an automobile; a helmet; and a packaging container.

3. A method according to claim 2, wherein the packaging container is selected from the group consisting of: a food package; a drink package; a box; a medicine container; and an envelope.

4. A method according to claim 1, wherein the pressure sensitive material is selected from the group consisting of: a coating, a film, and an adhesive.

5. A method according to claim 1, wherein each dye is a microencapsulated dye.

6. A method according to claim 5, wherein at least one dye is a fluorescent dye.

7. A method according to claim 5, wherein each dye undergoes a color change when exposed to the activator.

8. A method according to claim 5, wherein at least one dye is a leuco dye and the activator is an acid having a pKa less than that of the dye.

9. A method according to claim 8, wherein the activator is selected from the group consisting of: phenols, substituted phenols; solid acids; and polymeric acids.

10. A method according to claim 8, wherein at least one dye is a pH sensitive dye.

11. A method according to claim 10, wherein the pH sensitive dye is selected from the group consisting of: quinine, fluorescein, and calcein.

12. A method according to claim 1, wherein each dye is different.

13. A method according to claim 1, wherein at least one activator is a microencapsulated activator.

14. A method according to claim 13, wherein at least one dye is a leuco dye and at least one activator is an acid having a pKa less than that of the dye.

15. A method according to claim 1, wherein at least one dye and at least one activator are co-encapsulated.

16. A method according to claim 15, wherein the co-encapsulated dye is surrounded by a barrier layer and the co-encapsulated activator forms an outershell surrounding the barrier layer.

17. A method according to claim 15, wherein the co-encapsulated activator is surrounded by a barrier layer and the co-encapsulated dye forms an outershell surrounding the barrier layer.

18. A method according to claim 1, wherein the pressure sensitive material is applied to the article by coating the article.

19. A method according to claim 1, wherein the pressure sensitive material is applied to the article by wrapping the pressure sensitive material around the article and heat-shrinking the pressure sensitive material into place.

20. A method according to claim 1, wherein the color change is a visual color change.

21. A method according to claim 20, further comprising the step of determining pressure strength by observing color intensity.

22. A method according to claim 1, further comprising the step of observing the pressure sensitive material under ultraviolet light after the pressure sensitive material has been exposed to pressure.

23. A method according to claim 22, further comprising the step of determining pressure strength by observing color intensity.

24. A method according to claim 1, wherein each dye is microencapsulated and wherein each microencapsulated dye has an outershell wherein each outershell is sensitive to a different pressure.
